(19) United States
(12) Patent Application Publication
(10) Pub. No.: US 2008/0261003 A1
(43) Pub. Date: Oct. 23, 2008

(54) Improvements in and Relating to Image Articles

(76) Inventors: David Malcolm Lewis, West Yorkshire (GB); Peter Jeffrey Broadbent, North Yorkshire (GB)

Correspondence Address: NIXON & VANDERHYE, PC, 901 NORTH GLEBE ROAD, 11TH FLOOR, ARLINGTON, VA, 22203, US

(21) Appl. No.: 11/628,533

(22) PCT Filed: May 10, 2005
(86) PCT No.: PCT/GB2005/001763

§ 371 Date: Aug. 15, 2007

(30) Foreign Application Priority Data
Jun. 9, 2004 (GB) 0412817.9

(51) Int. Cl. B32B 3/00; B32B 37/00

(52) U.S. Cl. 428/206; 156/62.2; 118/300

(57) ABSTRACT

The invention relates to a method of manufacturing an image article comprising the steps of:
(a) providing a substrate;
(b) coating a water-soluble agent capable of adhering solid particles when wetted with an aqueous medium, on at least a portion of the substrate; the water-soluble agent being wetted with an aqueous medium, and
(c) applying solid particles to at least a portion of the water-soluble agent, to form an image.

The invention further relates to image articles produced by the method of the invention.

### FIELD OF THE INVENTION

The present invention relates to methods of manufacturing image articles, and image articles per se. In particular, but not exclusively, the invention relates to methods of manufacturing image articles using ink jet printing techniques.

### BACKGROUND TO THE INVENTION

There are many known chemical compounds which have useful security printing characteristics. For example, thermochromic agents and photochromic agents have the capability of changing colour depending on the heat or light characteristics in the region of the material. Thermochromic materials may be colourless at ambient temperatures and become coloured at lower than ambient temperatures or higher than ambient temperatures, or alternatively, may be coloured at ambient temperatures and change to colourless on raising or lowering the temperature. Photochromic agents may be coloured under ambient light, but turn colourless when exposed to ultraviolet radiation or infrared radiation; or alternatively, may be colourless under ambient lighting conditions, but turn coloured when exposed to UV or infrared radiation. These compounds are useful when manufacturing security articles such as identification cards, seals for packaging and the like.

Security articles such as identity cards and package sealing may, for example, include an image which cannot be seen under ambient conditions, comprising of thermochromic or photochromic material, but when stimulated with a different wavelength of radiation, or heat or cold, is changed to reveal a coloured image. In this way, it is possible for persons to determine whether packaging is authentic or counterfeited, and whether an identity card is a counterfeit identity card or not.

Many thermochromic and photochromic materials, phosphors and metal particles are in the form of solid particles such as powder or granules, which may be utilised per se, but due to technological restraints, have previously been applied to substrates from dispersions, whether viscous or fluid. This has restricted their use to specific printing techniques such as screen printing, lithographic printing, intaglio and the like. Many phosphors have a particle size too large for conventional types of printing. Although the use of phosphors, photochromics and thermochromics are well established, using the above printing processes, they suffer from disadvantages such that the cost for mass producing articles using these techniques is prohibitive, and the apparatus needed to utilise these techniques effectively is too bulky and expensive for individual consumers to utilise.

Equally the wastage of ink when utilising these materials reduces the usefulness of these relatively expensive solid particles; for example, in intaglio printing up to 70% of the paste/ink can be lost due to the inefficiency of the process when utilising solid particles.

Furthermore, known methods of incorporating thermochromic and photochromic agents into image articles include the use of organic solvents and other ancillary chemicals, which raises the cost of preparing the image article considerably. It would be advantageous to be able to apply images to substrates, containing thermochromic or photochromic materials, which can utilise water-based systems with the minimum of ancillary chemicals. It would furthermore be useful to provide methods of manufacturing image articles using thermochromic and photochromic solid particles without the need to dissolve or suspend the particles in solvents or liquid in order to apply the particles.

Many other solid particles can be used to image substrates, but conventional printing techniques generally necessitate the particles to be dissolved and/or suspended in solutions and liquid. Such particles could include metal particles, activated charcoal, phosphors, mica pearlescent pigments and the like. Again, it would be advantageous to provide methods of printing image articles utilising solid particles, in which the solid particles could be printed onto a substrate directly without the use of solvents or suspending liquids. Adherence of solid particle matter to a substrate can be difficult without the use of dispersions from which to lay down the particles, which may also need adhesives present in the dispersion. Solid particles create particular problems in printing apparatus which utilise spray heads or small diameter nozzles, as they may block the nozzles and damage the apparatus.

Phosphors generally comprise inorganic particles, such as zinc sulphide activated with copper, and emit phosphorescence. They have a large particle size which is not generally useful in printing from dispersions due to the large particle size blocking print heads. If the large particles are ground to small sizes, these inorganic phosphors generally lose their phosphorescence. The embodiments of the present invention have the object to overcome this problem.

Known printing techniques for applying solid particles to substrates generally involve blanket coating of a single tone image or raised image having a single elevation. It would be advantageous to provide image articles comprising an image formed from solid particles, which images comprise a plurality of tones, densities or elevations, for example, and which images could be applied in a simple manner using relatively inexpensive image printing equipment and materials.

It would also be useful to provide methods of manufacturing image articles, especially security prints, in which conventional ink jet technology can be utilised.

It would furthermore be advantageous to be able to print solid particles or substrates, using conventional printing technology, especially ink-jet technology, at high speeds (preferably greater than 200 m/min).

It is therefore an aim of preferred embodiments of the present invention to overcome or mitigate at least one problem in the prior art, whether expressly disclosed herein or not

### SUMMARY OF THE INVENTION

According to the present invention in a first aspect there is provided a method of manufacturing an image article comprising the steps of:
(a) providing a substrate;
(b) coating a water-soluble agent capable of adhering solid particles when wetted with an aqueous medium, on at least a portion of the substrate; the water-soluble agent being wetted with an aqueous medium, and
(c) applying solid particles to at least a portion of the water-soluble agent, to form an image.

Preferably different areas of the coating of the water-soluble agent are differentially wetted with an aqueous medium. Thus, when differentially wetted, the coating of water-soluble agent effects differential adhesive strength across different regions of the water-soluble agent, and therefore may selectively adhere varying concentrations of solid particles on different regions of the substrate.

The water-soluble agent may be differentially wetted by applying different amounts of aqueous medium containing the water-soluble agent to different areas of the coating of water-soluble agent. Alternatively or additionally, the water-soluble agent may be differentially wetted by coating the water-soluble agent on the substrate at different concentrations in an aqueous medium over different areas of the substrate. Alternatively or additionally, the water-soluble agent may be coated onto the substrate, dried, then differentially wetted by applying different amounts of aqueous medium to different areas of the coating of water-soluble agent.

Thus the present invention provides a method of printing an image using a “tacky” water-soluble agent to adhere solid particles to a substrate. The water-soluble agent, when wetted, becomes “tacky”, or adhesive, and due to its water-soluble nature, can be laid down on the substrate by many conventional printing techniques.

Suitably, the substrate is a sheet material, which may be planar or otherwise. The substrate may comprise any suitable material, such as paper, card, wood, glass, metal (including alloy), ceramic, stone, mineral, including mineral-based paper, plastics, hair and keratinous substances, composite, polymeric, or textile material, for example. Suitable textile material includes leather, cotton, synthetic textiles such as polyester, nylon or rayon, linen, flax, hemp, jute and silk.

Preferred substrates are sheets of card, paper, plastics, textile materials or metal.

Suitable plastics materials include polyurethanes, polyesters, poly vinyl chlorides, polyamides, and mixtures and co-polymers thereof.

Preferably the water-soluble agent capable of adhering solid particles when wetted with an aqueous medium comprises a saccharide or water-soluble polymer.

Saccharides are particularly useful water-soluble agents capable of adhering solid particles. Saccharides may be applied in solution, to create a “tacky” adhesive surface coating able to adhere a wide range of solid particles. Saccharides also have the property of being cross-linkable to further bind the saccharide to the substrate and any solid particles to the saccharide. Saccharides are cheap and abundant, and do not interfere with the chemical mechanisms of many of the target solid particles useful in the invention, such as thermochromic and photochromic materials. Saccharides may also contribute to coloured images. If they are heated above certain temperatures, then the saccharides may oxidize and turn brown or black, contributing to any image formed by the solid particles adhered thereto. Saccharides are highly soluble in water, and therefore their use is relatively environmentally friendly. Aqueous solutions of saccharides may be conveniently ink jet printed, without damaging or clogging ink jet print heads.

Preferred saccharides include monosaccharides, disaccharides, oligosaccharides and polysaccharides.

Preferred monosaccharides include glucose, fructose, tagatose and galactose.

Preferred disaccharides include sucrose, mannose and lactose.

Preferred polysaccharides include starch, cellulose, hydroxylalkycelluloses, cyclodextrins, chitosan and derivatives thereof.

Suitable water-soluble polymers include polyvinyl alcohol, polyvinylpyrrolidone, polyvinylacetate, polyacrylic acid, polyacrylates, active acrylic polymers, gelatins, carboxyalkylcelluloses, alginates, guar gum, locust bean gum, polymeric surfactants and polyols. Suitable reactive water-soluble polymers include those sold under the trade names NonaxAS® supplied by Cognis, Germany, Synthappret BAP®, supplied by Bayer, Germany, and Hercosett 125®, supplied by Hercules. The polymers are preferably self cross-linkable under a suitable stimulus, or may be cross-linked by addition of a suitable stimulus.

Preferred water-soluble polymers comprise one or more hydroxyl groups.

The water-soluble agent may contain a single saccharide, or water-soluble polymer, or may contain a plurality of saccharides, water-soluble polymers or a mixture of both one or more saccharides and one or more water-soluble polymers.

The water-soluble agent may be coated on the substrate in an aqueous solution and, the solvent may be partially removed from the coating to effect wetting of the water-soluble agent, and thus the adhesive properties of areas of the coating to solid particles. The strength of the adhesive properties of the wetted water-soluble agent is proportional to the amount of water present. Suitably the water-soluble agent is present in the aqueous solution before coating the substrate in an amount of at least 5% w/v of the total weight of the aqueous solution, more preferably at least 10% w/v, still more preferably at least 15% w/v and most preferably at least 20% w/v.

Preferably the solvent is partially removed in varying amounts from different areas of the coating to effect differential wetting of different areas of the coating and thus effect different adhesive strength to solid particles across different areas of the coating.

Alternatively or additionally different concentrations of water-soluble agent in an aqueous media may be coated on different areas of the substrate and the solvent partially evaporated, or differentially partially evaporated to effect a coating having regions of differential adhesive strength.

Alternatively or additionally, differential wetting of the water-soluble agent may be effected by varying the amount of aqueous solution or ink containing the water-soluble agent, coated on the substrate.

The aqueous solution may contain further ingredients, including humectants, lubricants, preservatives, dyes, pigments, surfactants, emulsifiers and the like, for example. Suitable preservatives include the Cibafast range of sulphonated benzotriazines, supplied by Ciba, UK.

The aqueous solution may contain one or more co-solvents, for example, alcohols such as methanol, ethanol, N-methylmorpholine-N-oxide and ethylene glycol, and the like.

Dyes, pigments or other colouring agents may be added to the aqueous medium.

The inclusion of dyes and pigments in the aqueous solution containing the water-soluble agent capable of adhering solid particles, allows for secondary images to be formed by coating the substrate with the aqueous solution. The solid particles subsequently applied to the water-soluble agent may for example be thermochromic or photochromic powders which are coloured or colourless at ambient conditions but turn colourless from coloured, or coloured from colourless, upon exposure to a suitable stimulus. If these particles are coated onto a substrate previously coated with a coating comprising the water-soluble agent and one or more dyes or pigment, then upon exposure to the stimulus, in the case of thermochromic or photochromic powders which are coloured at ambient conditions, the thermochromic or photochromic powders will turn colourless, revealing a coloured image formed by the pigment or dye in the undercoating. Likewise for thermochromic and photochromic powders that are colourless at ambient conditions, they will turn coloured, and obscure the coloured dye or pigment, or form a different colour due to blending of the colours of the dye/pigment and the photochromic/thermochromic powder. In this way, the aqueous solution containing a dye or pigment may be considered an ink.

In other embodiments a substrate may be coated with the water soluble agent capable of adhering solid particles when wetted with an aqueous medium, and subsequently image-wise coated with water and dye or pigment, to wet the water-soluble agent and image-wise apply a colour to the substrate. The coloured substrate may then be image-wise coated with solid particles such as thermochromic powder or photochromic powder.

Suitably the aqueous solution comprising the water-soluble agent is printed onto the substrate. Suitable printing methods include ink jet printing, roller printing, lithographic, or gravure printing and the like, but especially preferred is ink jet printing.

Ink jet printing is a preferred method of coating the aqueous solution or ink comprising the water-soluble agent. Ink jet printing is a very flexible form of printing, utilising relatively inexpensive equipment. Ink jet printers are commonly used in domestic environments as well as industrial environments. The use of ink jet printing allows for accurate image-wise printing of the aqueous solution or ink onto the substrate, in any desired image pattern. Ink jet printing also allows blanket printing of the entire substrate if desired. The use of saccharides or water-soluble polymers as the agents capable of adhering solid particles when wetted with an aqueous medium enables aqueous solutions to be prepared, which do not clog up or damage ink jet printing heads, and are able to be dispersed as a very fine spray or mist.

When the aqueous solution or ink containing the water-soluble agent is arranged to be ink-jet printed, preferably the solution or ink comprises an electrolyte to provide conductance to allow for ink-drop deflection in an electrical field, particularly for continuous ink-jet printing, in high-speed ink-jet printers.

The water-soluble agent preferably comprises a humectant, such as a polyalkylene glycol, glycol or the like, for example. Humectants are particularly useful for ink jet printing to prevent ink jet printing heads from drying out during application of the compositions.

The water-soluble agent may be applied to substantially the entire surface of the substrate or may be image-wise applied to a surface of the substrate. In particular the water-soluble agent may be image-wise applied to a surface of the substrate such that the dimensions of the coating of the water-soluble agent on the substrate correspond to the dimensions and position where it is desired to apply solid particles. Thus, the image-wise application of the water-soluble agent corresponds to the subsequent image-wise application of solid particles.

In preferred embodiments the water-soluble agent is applied to the substrate in solution, then the solvent or solvents substantially removed, and subsequently wetted with an aqueous medium, whether image-wise or over the entire coating of water-soluble agent.

If the substrate is entirely coated with the water-soluble agent then dried, the dried coating may be image-wise wetted with an aqueous medium, to create adhesive image areas capable of adhering solid particles. In this way step (b) may comprise coating the water-soluble agent in solution, drying the coating, and subsequently wetting at least a portion of the dried coating of the water-soluble agent. Suitably the dried water-soluble agent is image-wise differentially wetted by the aqueous medium such that different areas of the coating have different adhesive strength to solid particles.

Preferably the solid particles comprise a solid powder or granules, preferably dry particles. The size of the solid particles will depend on the nature of the solid and its intended use. If the particle size is relatively large, image-wise adhesion of the solid particles to the wetted water-soluble agent may affect embossing of the substrate, creating raised image areas, useful for example, as Braille text.

The solid particles preferably comprise any one or more agents selected from pigments (including pearlescent pigments), thermochromic materials, phosphors, photochromic materials, glass, polymeric beads and particles, activated charcoal or carbon, solid pigment toners (used in laser toner printing), metals (including alloys) or any mixture thereof.

Particularly preferred solid particles are thermochromic materials, photochromic materials, phosphors and magnetic metals. Particularly preferred methods utilise a saccharide in the water-soluble agent in step (b) and a thermochromic, photochromic or magnetic material in step (c).

It has been found that the adhesive property of wetted saccharides ensures efficient binding of thermochromic and photochromic materials to the substrate without detracting from their ability to change colour upon exposure to a suitable stimulant.

The solid particles may be applied to the substrate by any suitable method.

The substrate containing a coating of wetted water-soluble agent may be immersed in the solid particles, such that the solid particles adhere only to the wetted water-soluble agent. Excess particles may be removed by agitating the substrate after removal from the particles, such as shaking, tapping and the like, or by effecting airflow across the surface of the substrate comprising the water-soluble agent and particles.

Alternatively the whole area of the substrate coated with wetted water-soluble agent may be contacted with solid particles, such as by sprinkling, spreading or blowing solid particles onto the surface of the substrate coated with the water-soluble agent.

In some embodiments the solid particles may be printed onto the substrate, including by charged deposition (as in laser-toner printing). Printing of the solid particles allows image-wise application of the particles to all or a portion of the wetted water-soluble agent. For example if an entire surface of the substrate has been coated with wetted water-soluble agent then the solid particles may be image-wise applied, leaving areas of wetted water-soluble agent to which no particles are adherent. The non-adhered regions of the water-soluble agent may then be contacted with different solid particles dried to remove their adhesive properties, or removed or masked by any suitable method, such as washing or ablation.

Preferably the solid particles are image-wise applied to the water-soluble agent.

There may be a step after step (c) of drying the image article. Drying may be effected by allowing any solvents and water present to evaporate under ambient conditions, or by heating the image article to facilitate accelerated evaporation, for example. Drying may affect fulfillment of cross-linking if a cross-linking agent is present.

Step (c) may comprise applying a plurality of different types of solid particles to the wetted water-soluble agent. The different types of solid particles may be mixed together and applied in a single step. Alternatively or additionally the different types of particles may be applied separately and may be image-wise applied on different areas of wetted water-soluble agent to produce different image patterns.

The method may comprise repeating steps (b) and (c). For example, after wetted water-soluble agent has been image-wise coated onto the substrate and a first type of solid particle adhered to the wetted agent, a second coating of wetted water-soluble agent may be applied to at least a portion of the substrate, in the same or different image pattern to the first coating, and a second type of solid particle adhered to the second image coating of wetted water-soluble agent. In this way steps (b) and (c) may be repeated as many times as desired to build up an image on the substrate comprising a plurality of different solid particles.

In repeated steps (b), the subsequent coating of wetted water-soluble agent may be image-wise applied over areas of the substrate previously coated with wetted water-soluble agent, not previously coated, or mixtures thereof.

After each repetition of step (c), there may be a further step of drying the coated substrate. Thus, the substrate coated with wetted water-soluble agent to which solid particles are adhered may be dried before the next step (b) is repeated.

Step (c) may comprise contacting a plurality of different solid particle types on a plurality of different regions of the wetted water-soluble agent.

Once all of the desired solid particles are adhered to the substrate, preferably the coated substrate is dried to remove substantially all remaining solvent.

There may be a step after step (c), and preferably after drying, of fixing the image produced on the image article.

Fixing may be achieved by any suitable method, and may comprise fixing with a chemical agent, and/or fixing by physical means.

Where the water-soluble agent comprises a saccharide or water-soluble polymer, fixing may comprise cross-linking, chemical curing or physical curing. For example, if the water-soluble agent comprises a saccharide or water-soluble polymer containing hydroxyl groups, then a cross-linking agent such as DMDHEU (dimethyloldihydroxyethyleneurea) with or without catalysts, such as magnesium chloride.

If the substrate also comprises chemical groups that are capable of taking part in the cross-linking process, then the water-soluble agent may also bind the substrate surface, giving enhanced durability to subsequent washing and attrition. Examples of substrates having suitable groups include paper and card bearing hydroxyl groups, capable of being cross-linked by agents such as DMDHEU.

Some water-soluble polymers useful as the water-soluble agent such as NonaxAS, Synthappret BAP and Hercosett (all RTM), are self-crosslinking and become water-insoluble on drying and heat-curing.

Alternatively or additionally the image may be fixed by coating the image article with a suitable cover layer. The cover layer may comprise a layer of lacquer, paint or varnish, for example.

Alternatively or additionally the image may be fixed by laminating or affixing a cover sheet to the image article, over the image.

According to a second aspect of the present invention there is provided an image article comprising a substrate on which at least a portion is coated with a water-soluble agent capable of adhering solid particles when wetted, the water-soluble agent being wetted to effect solid particle adhesive properties, and an image comprising solid particles coated on at least a portion of the wetted water-soluble agent.

Preferably the water-soluble agent is differentially wetted to effect differential solid particle adhesive properties on different regions of the coating

The substrate, water-soluble agent and solid particles are preferably as described hereinabove for the first aspect of the invention.

The image article may comprise, for example, a printing form, an electronic part or a mask to a printing form or electronic part.

Suitable printing forms include printing plates, printing cylinders, identity cards, artworks, textiles such as clothing and the like.

The electronic part is preferably a printed circuit board.

According to a third aspect of the invention there is provided an image article produced by the method of the first aspect of the invention.

According to a fourth aspect of the present invention there is provided a printing apparatus comprising an ink-jet printer through which a substrate is arranged to pass, and a means to apply solid particles to the substrate downstream of the ink-jet printer.

The means to apply solid particles may comprise a receptacle in which the particles are located and into which or through which the substrate is arranged to pass. Alternatively, the means to apply solid particles may comprise means to spray or blow solid particles onto the substrate, downstream of the ink-jet printer. In other embodiments the means to apply solid particles may comprise a laser-toner apparatus.

The various aspects of the invention will now be described, by way of example only, in the following examples:

### EXAMPLES

### Example 1

Card and paper substrates were ink-jet printed with an ink comprising an agent capable of adhering solid particles, a saccharide, sucrose, on an Apollo P-1200 ink-jet printer, the solvent in the ink being allowed to partially evaporate to create an adhesive tacky sucrose coating to yield a printed image template which demonstrated solid particle adhesion properties; the ink being formulated in accordance with the following recipe:
400 gdm⁻³ Sucrose
5 gdm⁻³ Polypropylene glycol 425 supplied by Aldrich, UK
0.5 gdm⁻³ Cibafast W (Ciba), a sulphanated benetriazote preservative

Adjust to pH 8.5 via the addition of 10% w/v sodium hydroxide solution

De-ionised water to 1 litre

The wetted sucrose coating image template was then coated with a commercially available black 25° C. activating thermo-chromic powder (B+H The Colour Change Company) and any non-adhered particles removed by gently tapping the card, to form an image article. The printed image was fixed to the substrate by spraying the image with a commercially available clear acrylic lacquer spray (RS Components, UK). The resulting print achieved exhibited a black and white photographic quality image, which when heated above 25° C. became colourless; the black and white image returning when the print was cooled to below the above activation temperature.

### Example 2

The process described in Example 1 was repeated but in this case the sucrose solution was allowed to dry completely, then the covered substrate was differentially wetted, image-wise with water, such that different areas of the sucrose coating were wetted with different amounts of water to create areas having different adhesive strength to solid particles. The black thermochromic powder was then added as in Example 1, and different amounts adhered to different areas of the sucrose coating to effect a multi-tone greyscale. In this case the black and white photographic image was fixed to the substrate by laminating it between two clear polyester plastic sheets. A black and white photographic quality image was again achieved, which when heated above 25° C. became colourless; the black and white image returning when the print was cooled below the above activation temperature.

### Example 3

The process described in Example 1 was repeated, but in this case the black 25° C. thermo-chromic powder was replaced with a cyan thermochromic powder which activates (decolourises) at 15° C., to yield a colourless print. On cooling below the above activating temperature, a blue and white photographic quality image was achieved, which again became colourless on heating.

### Example 4

The process described in Example 1 was repeated but in this case, instead of sucrose, the ink contained 400 gdm⁻³ fructose. A black and white photographic quality image was again achieved, which when heated above 25° C. became colourless; the black and white image returning when the print was cooled.

### Example 5

The process described in Example 1 was repeated, but in this case, instead of sucrose, the ink contained 400 gdm⁻³ glucose. A black and white photographic quality image was again achieved, which when heated above 25° C. became colourless; the black and white image returning when the print was cooled.

### Example 6

The process described in Example 1 was repeated, but in this case the three inks were coated onto the substrate, each ink also contained a water soluble textile dye 30 gdm⁻³); the dyes used being Sumifix Supra Turquoise Blue BGF, Sumifix Supra Brilliant Yellow 3GF and Sumifix Supra Brilliant Red 3BF (Sumitomo, Japan). The method used to coat the substrate was as follows:

Three sucrose solutions (as described in Example 1) containing one each of the blue, red and yellow dyes were located in a standard tri-colour ink-jet cartridge and a multi-coloured image was printed onto the substrate as described in Example 1. The coated substrate became tacky due to the wetted sucrose coating and a black-thermochromic powder image-wise applied to the tacky coating at 25° C. The substrate was then thoroughly dried and fixed by laminating with a sheet of polyester. Thus, a multi-coloured image was printed by replacing the cyan, magenta and yellow inks present in a tri-colour ink-jet cartridge. On application of the 25° C. activating black thermo-chromic powder to the multi-coloured adhesive template, a black and white photographic quality image was again achieved. On heating the black and white image above 25° C., the multi-coloured image once more became visible; the black and white image returning when the print was cooled.

### Example 7

The process described in Example 6 was repeated, but in this case the black 25° C. activating thermo-chromic powder was replaced with a cyan 15° C. activating thermo-chromic powder. In this case, a multi-coloured image was achieved, which on cooling below 15° C. gave rise to a blue photographic quality image; the multi-coloured image returning once more as the print was heated above 15° C.

### Example 8

The process described in Example 1 was repeated, but in this case the thermo-chromic powder was replaced with a photo-chromic powder. The photo-chromic powder was prepared by dissolving a commercially available photo-chromic dye, Reversacol Flame Orange (supplied by James Robinsons, UK), in a clear polyurethane varnish and allowing the varnish to cure. The cured varnish was ground to a fine powder and then applied to the image template. A colourless photographic quality print was achieved, which on exposing to ultra-violet light became orange; the image eventually becoming colourless once more in the absence of ultra-violet light.

### Example 9

The process described in Example 1 was repeated, but in this case the thermo-chromic powder was replaced with a photo-chromic powder such as Reversacol Flame Orange (supplied by James Robinson, UK). The print was then dried and sprayed with an acrylic lacquer (RS Components, UK) to fix the print. The lacquer is important to enable the photochromic material to work effectively. A colourless photographic quality print was achieved, which on exposing to ultra-violet light became orange; the image eventually becoming colourless once more in the absence of ultra-violet light.

### Example 10

The process described in Example 1 was repeated, but in this case the black thermo-chromic powder was replaced with a red pigment powder, HD Pigment Red 112 (Holliday Dispersions, UK) to yield a red photographic quality print.

### Example 11

The process described in Example 1 was repeated, but in this case the black thermo-chromic powder was replaced with a yellow pigment powder, HD Pigment Yellow 74 (Holliday Dispersions, UK) to yield a yellow photographic quality print.

### Example 12

The process described in Example 1 was repeated, but in this case the black thermo-chromic powder was replaced with a black toner powder to yield a black photographic quality print.

### Example 13

The process described in Example 1 was repeated, but in this case the black thermo-chromic powder was replaced with carbon powder to yield a black photographic quality print.

### Example 14

An ink template was produced on card using the process described in Example 1, but in this case the printed inked image was coated with a scented activated solid carbon powder. The scented carbon powder was prepared by stirring activated carbon powder in an alcoholic solution of cologne. The powder was collected by filtration, dried at room temperature and finally applied to the sucrose template to yield a photographic quality black print which emitted a scented fragrance; the scented fragrance was retained in the print for many months.

### Example 15

The process described in Example 1 was repeated, but in this case the black thermo-chromic powder was replaced with ballotin (small glass beads). A photographic quality image was produced, which exhibited unusual optical effects dependent on viewing conditions.

### Example 16

A coloured adhesive template was printed on card in accordance with the procedure described in Example 6, but in this case the black thermo-chromic powder was replaced with ballotin to yield a photographic quality image, which exhibited unusual optical effects dependent on viewing conditions.

### Example 17

An adhesive sucrose template was printed on paper according to the process described in Example 1, but in this case the printed image was subsequently coated with glass ballotin. The ballotin print was put on top of several layers of paper and placed in a heated press (180° C.) for 30 second to yield a series of embossed prints in the covering paper sheets.

### Example 18

An adhesive sucrose template of the Braille alphabet was printed on paper using the process described in Example 1, but in this case the printed image was coated with glass ballotin. The raised print achieved was readily readable by touch for those capable of reading Braille, but could also be used as a printing plate to produce embossed prints as described in Example 17.

### Example 19

The process described in Example 1 was repeated, but in this case the black thermo-chromic powder was replaced with copper powder to produce a metallic photographic quality print.

### Example 20

The process described in Example 1 was repeated, but in this case the black thermo-chromic powder was replaced with tin powder to produce a metallic photographic quality print.

### Example 21

The process described in Example 1 was repeated, but in this case the black thermo-chromic powder was replaced with iron powder to produce a metallic photographic quality print. The iron print achieved could be readily verified by its attraction to a strong magnet. In addition the raised surface of the printed area indicated its potential for Braille printing.

### Example 22

The process described in Example 1 was used to produce a printed circuit, but in this case the black thermo-chromic powder was replaced with silver powder. The silver coated printed circuit formed was shown to be conductive along its length using a conductivity meter.

### Example 23

Paper and card substrates were coated with an aqueous solution of sucrose (400 gdm⁻³) (made up as in Example 1) using a K-bar and allowed to dry at room temperature. The pre-coated papers produced were differentially ink-jet printed with de-ionised water to activate the adhesive properties of the sucrose. The pre-coated papers were image-wise differentially wetted so that different areas had different adhesive strengths to particle. The ‘tacky’ image template was coated with a black 25° C. thermo-chromic powder whereby different areas of the tacky coating picked up differing amounts of particles to create a greyscale image of multiple tones. The excess powder was removed by gentle tapping to yield a black and white photographic quality print, which became colourless on heating above 25° C.; the black and white print returning as the print was cooled below the above activation temperature.

### Example 24

The process described in Example 23 was repeated, but in this case the black thermo-chromic powder was replaced with a cyan 15° C. activating thermo-chromic powder to yield a colourless print at room temperature, which became blue on cooling below 15° C.

### Example 25

The process described in Example 23 was repeated, but in this case the black thermo-chromic powder was replaced with iron powder to yield a photographic quality print which could be picked up using a magnet.

### Example 26

The process described in Example 23 was repeated, but in this case the papers were pre-coated with an aqueous solution which contained 400 gdm⁻³ fructose. The pre-coated papers again produced photographic quality images when they were ink-jet printed with de-ionised water and coated with a black 25° C. thermo-chromic powder.

### Example 27

The process described in Example 23 was repeated, but in this case the papers were pre-coated with an aqueous solution containing 400 gdm⁻³ glucose. The pre-coated papers again produced photographic quality images when they were ink-jet printed with de-ionised water and coated with a black 25° C. thermo-chromic powder.

### Example 28

The process described in Example 23 was repeated, but in this case the papers were pre-coated with an aqueous solution which contained 40 gdm⁻³ Nonax AS (Henkel, Germany). The pre-coated papers again produced photographic quality images when they were ink-jet printed with de-ionised water and coated with a black 25° C. thermo-chromic powder.

### Example 29

A polyester fabric was printed with the sucrose ink as described in Example 1. The wet image template was passed through navy blue particle dye (Disperse Blue 79, Yorkshire Chemicals, UK), shaken to remove excess dye and dried out and baked at 20° C. for 30 seconds. Cold water washing of the dyed fabric revealed a deep navy blue dyed image which was wash-fast.

### Example 30

Card and paper substrates were imaged in the following manner. An ink containing the following ingredients was ink-jet printed onto the substrate using an Apollo P-1200 printer to yield a first image template:
400 dm⁻³ sucrose
5 gdm⁻³ polyprophene glycol 345
0.5 gdm⁻³ Cibafast W (Ciba, UK)
adjust to pH 8.5 via the addition of 10% w/v sodium hydroxide
Deionised water to 1 litre

The inked template was allowed to partially dry to create a wetted sucrose coating capable of coating solid particles. A blank powdered pigment (C.I. Pigment Black 1, Cabot, USA) was then applied to the image template by immersing the substrate in a tray of the pigment. Excess pigment was removed by shaking the substrate. The substrate was thoroughly dried. The dried substrate was then image-wise coated with a second coating of the sucrose solution as described above to form a second image template, overlying the first coating. A blue powder pigment was then coated onto the wetted sucrose as described above and the substrate dried. The process was repeated a third and fourth time using yellow and red pigments to create a four layer image coating of black, blue, yellow and red pigments. The coated substrate was then fixed by coating with a commercially available acrylic lacquer (RS Components, UK).

### Example 31

The process described in Example 1 was repeated, but in this case the thermo-chromic powder was replaced with a red inorganic phosphor powder, PTR610/F (Phosphor Technology). Under normal office lighting conditions, a colourless print was observed, but under UV light at 254 nm, a strong red phosphorescent photographic quality image was achieved; the image once more becoming colourless on removal from the UV light source.

### Example 32

The process described in Example 1 was repeated, but in this case the thermo-chromic powder was replaced with a green inorganic phosphor powder, PTG505/F (Phosphor Technology). Under normal office lighting conditions, a colourless print was observed, but under UV light at 254 or 365 nm, a strong green phosphorescent photographic quality image was achieved; the image once more becoming colourless on removal from the UV light source.

### Example 33

The process described in Example 1 was repeated, but in this case the thermo-chromic powder was replaced with a red pearlescent mica pigment powder, Iriodin 215 Rutile Red pearl (Merck). Under normal office lighting conditions, a photographic quality image was observed, which exhibited optical variable image (OVI) properties; the print being observed as a pinkish-red image when viewed from one particular angle, but on viewing from an alternative angle, a greenish image was achieved.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A method of manufacturing an image article comprising the steps of:
(a) providing a substrate;
(b) coating a water-soluble agent capable of adhering solid particles when wetted with an aqueous medium, on at least a portion of the substrate; the water-soluble agent being wetted with an aqueous medium, and
(c) applying solid particles to at least a portion of the water-soluble agent, to form an image.

2. A method as claimed in claim 1 wherein different areas of the coating of the water-soluble agent are differentially wetted with an aqueous medium.

3. A method as claimed in claim 2 wherein the water-soluble agent is differentially wetted by coating the water-soluble agent on the substrate at different concentrations in an aqueous medium, over different areas of the substrate.

4. A method as claimed in claim 2 wherein the water-soluble agent is coated onto the substrate, then the substrate is differentially wetted by applying different amounts of aqueous medium to different areas of the dried coating of water-soluble agent.

5. A method as claimed in claim 1 wherein the water-soluble agent capable of adhering solid particles when wetted with an aqueous medium comprises a saccharide or water-soluble polymer.

6. A method as claimed in claim 5 wherein the saccharide is selected from glucose, fructose, sucrose, cellulose and chitosan.

7. A method as claimed in claim 5 wherein the water-soluble polymer is selected from polyvinyl alcohol, polyvinylpyrrolidone, polyvinylacetate, polyacrylic acid, polyacrylates, active acrylic polymers, gelatins, carboxyalkylcelluloses, alginates, guar gum, locust beam gum, polymeric surfactants and polyols.

8. A method as claimed in any claim 1 wherein a dye, pigment or other colouring agent is added to the water-soluble agent.

9. A method as claimed in claim 8 wherein the substrate is coated with the water-soluble agent capable of adhering solid particles when wetted with an aqueous medium, and subsequently image-wise coated with water and dye or pigment, to wet the water-soluble agent and image-wise apply a colour to the substrate.

10. A method as claimed in claim 1 wherein the aqueous solution comprising the water-soluble agent is printed onto the substrate.

11. A method as claimed in claim 1 wherein the water-soluble agent is applied to substantially the entire surface of the substrate or image-wise applied to a surface of the substrate.

12. A method as claimed in claim 1 wherein the solid particles comprise solid powder or granules.

13. A method as claimed in claim 12 wherein the solid particles comprise any one or more agents selected from pigments (including pearlescent pigments), thermochromic materials, phosphors, photochromic materials, glass, polymeric beads and particles, activated charcoal or carbon, solid pigment toners (used in laser toner printing), metals (including alloys) or any mixture thereof.

14. A method as claimed in claim 1 wherein the substrate containing a coating of wetted water-soluble agent is immersed in the solid particles, such that the solid particles adhere only to the wetted water-soluble agent.

15. A method as claimed in claim 1 wherein the solid particles are printed onto the substrate.

16. A method as claimed in any preceding claim wherein the method further comprises a step after step (c) of drying the image article.

17. A method as claimed in claim 1 wherein step (c) comprises applying a plurality of different types of solid particles to the wetted water-soluble agent.

18. A method as claimed in claim 17 wherein the different types of particles are applied separately and are image-wise applied on different areas of wetted water-soluble agent to produce different image patterns.

19. A method as claimed in claim 1 comprising repeating steps (b) and (c).

20. A method as claimed in claim 19 wherein in repeated steps (b), a subsequent coating of wetted water-soluble agent is image-wise applied over areas of the substrate previously coated with wetted water-soluble agent, not previously coated, or any mixture thereof.

21. A method as claimed in claim 19 wherein, after each repetition of step (c), there is a further step of drying the coated substrate.

22. A method as claimed in claim 1 wherein after step (c), there is a further step of fixing the image produced on the image article.

23. A method as claimed in claim 22 wherein fixing is by contacting the substrate with a chemical agent, and/or fixing by physical means.

24. An image article comprising a substrate on which at least a portion is coated with a water-soluble agent capable of adhering solid particles when wetted, the water-soluble agent being wetted to effect solid particle adhesive properties, and an image comprising solid particles coated on at least a portion of the wetted water-soluble agent.

25. An image article as claimed in claim 22 comprising a printing form, an electronic part or a mask to a printing form or electronic part.

26. An image article as claimed in claim 24, produced by the method of as defined above.

27. A printing apparatus comprising an ink-jet printer through which a substrate is arranged to pass, and a means to apply solid particles to the substrate downstream of the ink-jet printer.

28. A method as substantially described herein with reference to the accompanying examples.

29. An image article substantially as described herein, with reference to the accompanying examples.
